(19) United States
(12) Patent Application Publication
(10) Pub. No.: US 2010/0233572 A1
(43) Pub. Date: Sep. 16, 2010

(54) FUEL CELL

(76) Inventors: Akira Yajima, Tokyo (JP); Jun Momma, Kanagawa-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/679,439

(22) PCT Filed: Sep. 2, 2008
(86) PCT No.: PCT/JP2008/002394

§ 371 Date: Mar. 22, 2010

(30) Foreign Application Priority Data
Sep. 27, 2007 (JP) 2007 251653

(51) Int. Cl. H01M 8/10

(52) U.S. Cl. 429/483

(57) ABSTRACT

The present invention relates to a fuel cell including: a membrane electrode assembly 10 having an electrolyte membrane 17 sandwiched by a fuel electrode 13 and an air electrode 16; a fuel supply part 43 disposed on the fuel electrode side of the membrane electrode assembly to supply a fuel to the fuel electrode 13; a fuel storage part 41 storing the fuel; and a fuel channel 44 leading the fuel stored in the fuel storage part to the fuel supply part. Since a fuel cell can generate electricity for a long time by being continuously supplied with a fuel, the fuel cell serves as a system advantageous as a power source of a portable electronic device such as a portable phone if it can be made compact. Here, if a user keeps touching a high-temperature portion of the fuel cell, he/she may suffer from low-temperature burn or the like, and therefore, some measure such as providing a heat insulator is necessary, but sufficient heat insulation results in excessively large weight and volume, which leads to a problem that the fuel cell is not suitable as a power source of a portable electronic device. The present invention solves the above problem by the structure in which the fuel channel 44 in the fuel cell is formed as a channel heating the fuel by heat generated in the air electrode and leading the heated fuel to the fuel supply part.

### TECHNICAL FIELD

The present invention relates to a fuel cell using a liquid fuel.

### BACKGROUND ART

In recent years, in order to enable long-hour use of various kinds of portable electronic devices such as laptop personal computers and portable phones without charging, attempts have been made to use fuel cells as power sources of these portable electronic devices. The fuel cell has a feature that it is capable of generating electricity only by being supplied with a fuel and air and is capable of continuously generating electricity for long hours by being replenished with the fuel. Therefore, the fuel cell can be an extremely advantageous system as a power source of portable electronic devices if it can be made compact.

A direct methanol fuel cell (DMFC) is expected to be a promising power source of portable electronic devices because it can be made compact and its fuel can be handled easily. As a method of supplying a liquid fuel in the DMFC, there have been known an active method such as a gas supply type and a liquid supply type, and a passive method such as an internal vaporization type in which a liquid fuel in a fuel storage part is vaporized inside the cell and the vaporized liquid fuel is supplied to a fuel electrode.

Among them, the passive method such as the internal vaporization type is especially advantageous in terms of the miniaturization of the DMFC. For example, WO 2005/112172 A1 proposes a passive-type DMFC which is structured such that a membrane electrode assembly (fuel cell unit) having an anode (fuel electrode), an electrolyte membrane, and a cathode (air electrode) is disposed on a fuel storage part which is a box-shaped container made of resin. In the direct supply of a fuel vaporized from the fuel storage part to the fuel cell unit, it is important to enhance controllability of an output of the fuel cell, but sufficient controllability has not necessarily been obtained in the current passive-type DMFC.

Meanwhile, for example, in JP-A 2005-518646 (KOHYO), JP-A 2006-085952 (KOKAI), and US 2006/0029851 A1, connecting a fuel cell unit and a fuel storage part via a channel in a DMFC is considered. Since a liquid fuel supplied from the fuel storage part is supplied to the fuel cell unit via the channel, it is possible to adjust a supply amount of the liquid fuel based on the shape, diameter, and the like of the channel. For example, JP-A 2006-085952 (KOKAI) describes a fuel cell using a pump for supplying a liquid fuel from a fuel storage part to a channel. Further, US 2006/0029851 A1, for example, describes a fuel cell using an electroosmotic flow pump for supplying a liquid fuel or the like.

Further, in a fuel cell in which the above-described membrane electrode assemblies are disposed two-dimensionally, an edge portion of the membrane electrode assembly radiates a large amount of heat to the surrounding atmosphere or the like and thus has a low temperature, which sometimes prevents the promotion of a chemical reaction in an anode catalyst layer and a cathode catalyst layer in this edge portion. Further, in the fuel cell of the internal vaporization type in which a gaseous fuel is generated by the vaporization of a fuel inside the fuel cell, heat generated in the membrane electrode assembly is often used as a heat source causing the vaporization of the fuel. In this case, in the edge portion, due to the low temperature of the membrane electrode assembly itself, it is not sometimes possible to obtain a heat quantity large enough to vaporize the fuel. In the edge portion of the membrane electrode assembly not having a heat quantity large enough to vaporize the fuel, an amount of the supplied gaseous fuel becomes small and the output sometimes further lowers. On the contrary, in a center portion of the membrane electrode assembly, the temperature becomes high because heat is not easily radiated therefrom to the surrounding atmosphere or the like, so that an amount of the supplied gaseous fuel increases and the output tends to become high.

Here, JP-A 2000-133295 (KOKAI), for example, discloses an art in which in a fuel cell combined cycle power plant, a fuel to be supplied to a fuel cell is pre-heated through a heat exchanger for fuel heating and thereafter is supplied to the fuel cell.

As described above, in the conventional fuel cell in which the membrane electrode assemblies are disposed two-dimensionally, the edge portion has a low temperature and the center portion has a high temperature, resulting in a large temperature difference between the center portion and the edge portion. For example, when the fuel cell is used as a power source of a portable device, there is a risk that a user may suffer from low-temperature burn or the like if he/she keeps touching the high-temperature center portion of the fuel cell for long hours, and therefore, a decrease in the temperature of the high-temperature center portion is needed. However, if the temperature near the center portion is lowered to a temperature that is sufficiently safe for a user, the temperature of the edge portion becomes further lower, which leads to a problem of lowering an output obtained as the whole fuel cell.

Therefore, in order to ensure safety of a user while maintaining a high output of the fuel cell, it is necessary to take a measure such as providing a heat insulator between the membrane electrode assembly and a surface member of the fuel cell to prevent the heat of the high-temperature portion of the membrane electrode assembly from being directly transferred to the surface member. However, an attempt to achieve sufficient heat insulation results in an excessively large weight and volume of the heat insulator, which leads to such a problem that the fuel cell is not suitable for use as a power source of a portable device.

Patent Reference 1: WO 2005/112172 A1

Patent Reference 2: JP-A 2005-518646 (KOHYO)

Patent Reference 3: JP-A 2006-085952 (KOKAI)

Patent Reference 4: US 2006/0029851 A1

Patent Reference 5: JP-A 2000-133295 (KOKAI)

### DISCLOSURE OF THE INVENTION

Under such circumstances, it is an object of the present invention to provide a fuel cell which can be prevented from locally having a high temperature on its surface while maintaining a high power, thereby realizing improved safety when in use.

According to an aspect of the present invention, there is provided a fuel cell including: a membrane electrode assembly having a fuel electrode, an air electrode, and an electrolyte membrane sandwiched by the fuel electrode and the air electrode; a fuel supply part disposed on the fuel electrode side of the membrane electrode assembly to supply a fuel to the fuel electrode; a fuel storage part storing the fuel; and a fuel channel heating and leading the fuel stored in the fuel storage part to the fuel supply part, the fuel channel heating by heat generated in the air electrode.

According to another aspect of the present invention, there is provided a fuel cell including: a membrane electrode assembly having a fuel electrode, an air electrode, and an electrolyte membrane sandwiched by the fuel electrode and the air electrode; a fuel supply part disposed on the fuel electrode side of the membrane electrode assembly to supply a fuel to the fuel electrode; a fuel storage part storing the fuel while heating the fuel by heat generated in the air electrode; and a fuel channel leading the fuel stored in the fuel storage part to the fuel supply part.

### BRIEF DESCRIPTION OF DRAWINGS

FIG. 1 is a cross-sectional view showing the structure of a fuel cell according to a first embodiment of the present invention.

FIG. 2 is a plane view showing the structure of a surface cover when the surface cover is seen from above the fuel cell in FIG. 1, that is, from the outside of the fuel cell.

FIG. 3 is a plane view showing another layout example of a heating part of a channel.

FIG. 4 is a cross-sectional view showing another structure of the channel in the fuel cell of the first embodiment according to the present invention.

FIG. 5 is a cross-sectional view showing still another structure of the channel in the fuel cell of the first embodiment according to the present invention.

FIG. 6 is a cross-sectional view showing the structure when the fuel cell of the first embodiment according to the present invention includes a pump.

FIG. 7 is a cross-sectional view showing the structure of a fuel cell of a second embodiment according to the present invention.

FIG. 8 is a plane view showing the structure when the fuel cell in FIG. 7 is seen from above the fuel cell.

### EXPLANATION OF NUMERALS AND SYMBOLS

1 . . . fuel cell, 10 . . . fuel cell unit, 11 . . . anode catalyst layer, 12 . . . anode gas diffusion layer, 13 . . . anode (fuel electrode), 14 . . . cathode catalyst layer, 15 . . . cathode gas diffusion layer, 16 . . . cathode (air electrode), 17 . . . electrolyte membrane, 18 . . . anode conductive layer, 19 . . . cathode conductive layer, 20 . . . O-ring, 30 . . . fuel distribution layer, 31 . . . opening, 40 . . . fuel supply mechanism, 41 . . . fuel storage part, 42 . . . fuel supply part main body, 43 . . . fuel supply part, 44 . . . channel, 44a . . . heating part, 50 . . . moisture retention layer, 60 . . . surface cover, 61 . . . air inlet port, 70 . . . channel support member, F . . . liquid fuel

### BEST MODE FOR CARRYING OUT THE INVENTION

Hereinafter, embodiments of the present invention will be described with reference to the drawings.

### First Embodiment

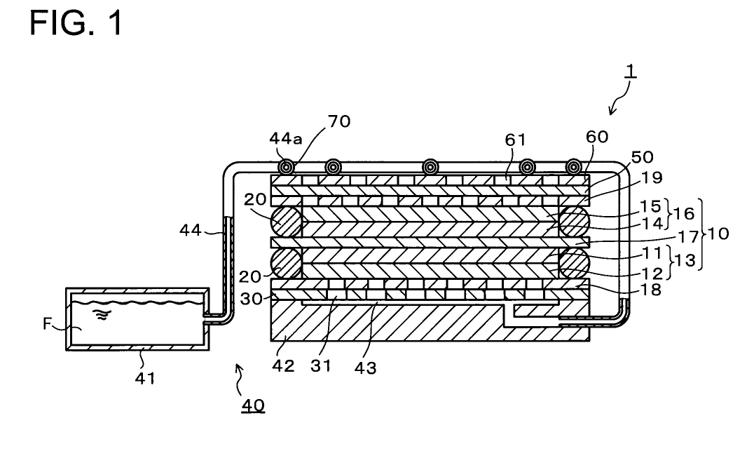

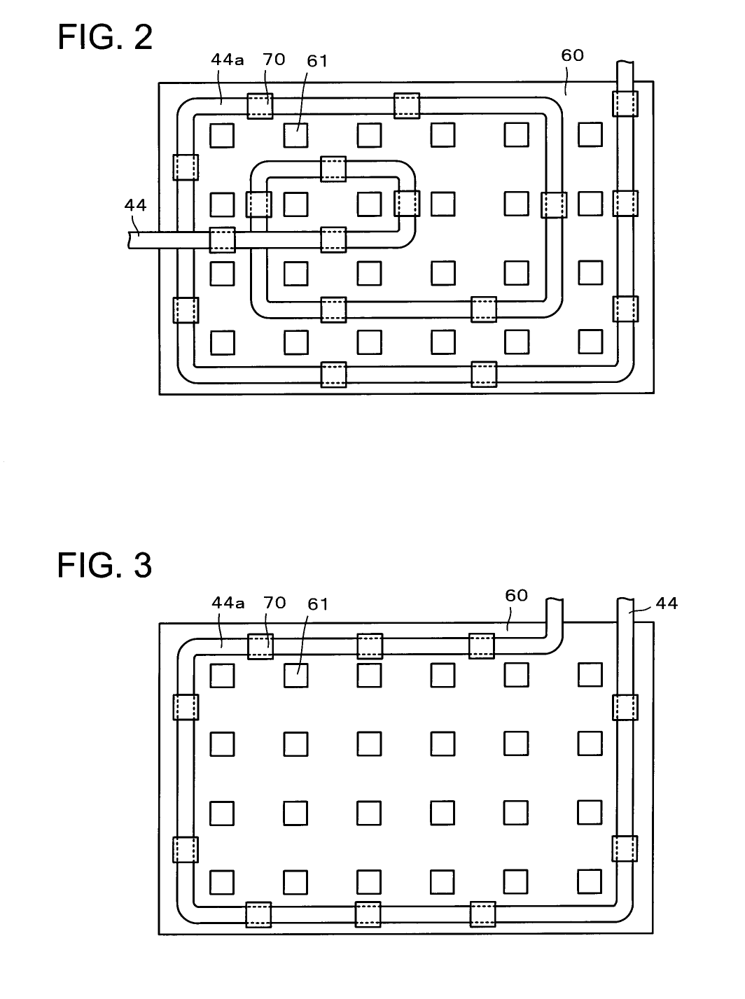

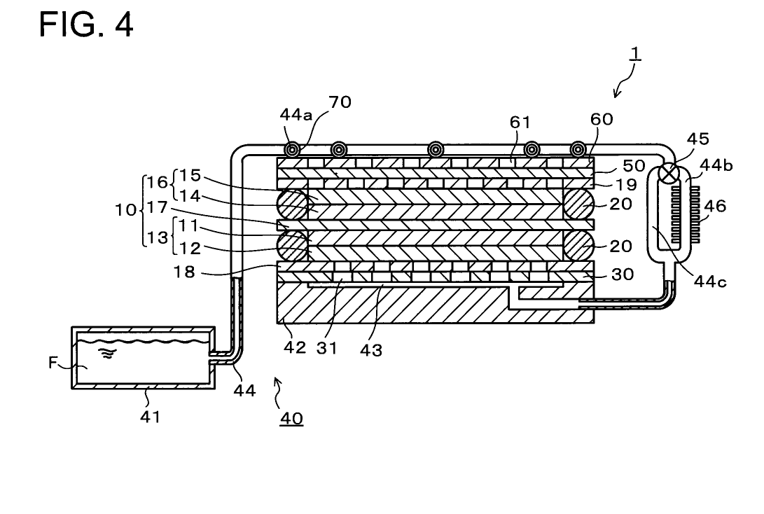

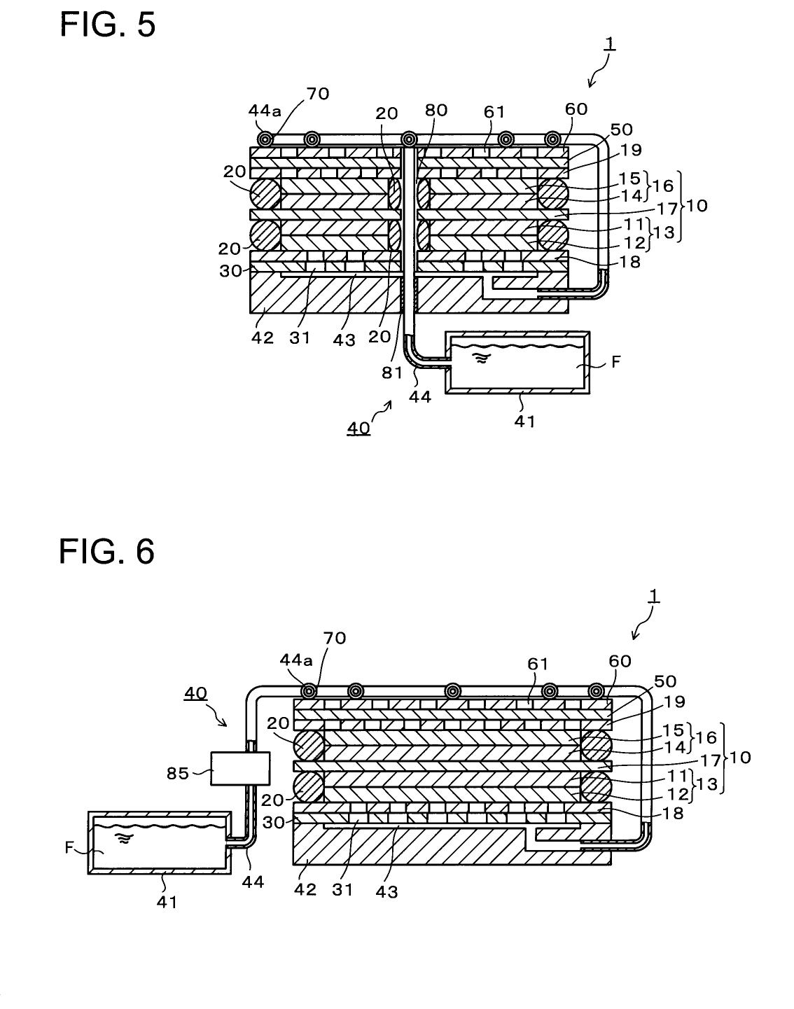

FIG. 1 is a cross-sectional view showing the structure of a fuel cell 1 of a first embodiment according to the present invention. FIG. 2 is a plane view showing the structure of a surface cover 60 when the surface cover 60 is seen from above the fuel cell 1 in FIG. 1, that is, from the outside of the fuel cell 1. FIG. 3 is a plane view showing another layout example of a heating part 44a of a channel 44. FIG. 4 is a cross-sectional view showing another structure of the channel 44 in the fuel cell 1 of the first embodiment according to the present invention. FIG. 5 is a cross-sectional view showing still another structure of the channel 44 in the fuel cell 1 of the first embodiment according to the present invention. FIG. 6 is a cross-sectional view showing the structure when the fuel cell 1 of the first embodiment according to the present invention includes a pump 85.

As shown in FIG. 1, the fuel cell 1 has: a fuel cell unit 10 constituting an electromotive part; an anode conductive layer 18 and a cathode conductive layer 19 provided on an anode (fuel electrode) side and a cathode (air electrode) side of the fuel cell unit 10 respectively; a fuel distribution layer 30 provided to face the anode conductive layer 18 and having a plurality of openings 31; a fuel supply mechanism 40 disposed opposite the fuel cell unit 10 across the fuel distribution layer 30 to supply a liquid fuel F to the fuel distribution layer 30; a moisture retention layer 50 stacked on the cathode conductive layer 19; and a surface cover 60 stacked on the moisture retention layer 50 and having a plurality of air inlet ports 61. Further, a channel 44 constituting part of the fuel supply mechanism 40 and provided between a fuel storage part 41 and a fuel supply part 43 is partly supported and fixed by channel support members 70 provided on the surface cover 60 which is a constituent member disposed on the cathode (air electrode) side.

The fuel cell unit 10 is what is called a membrane electrode assembly (MEA) and is composed of an anode (fuel electrode) 13 having an anode catalyst layer 11 and an anode gas diffusion layer 12, a cathode (air electrode) 16 having a cathode catalyst layer 14 and a cathode gas diffusion layer 15, and an electrolyte membrane 17 sandwiched by the anode catalyst layer 11 and the cathode catalyst layer 14 and having proton (hydrogen ion) conductivity.

Examples of catalysts contained in the anode catalyst layer 11 and the cathode catalyst layer 14 are elemental substances of platinum-group elements such as Pt, Ru, Rh, Ir, Os, and Pd, alloys containing a platinum-group element, and the like. For the anode catalyst layer 11, it is preferable to use, for example, Pt—Ru, Pt—Mo, or the like having high resistance against methanol, carbon monoxide, and the like. For the cathode catalyst layer 14, it is preferable to use, for example, Pt, Pt—Ni, Pt—Co, or the like. However, the catalysts are not limited to these, and various kinds of substances having catalytic activity can be used. The catalysts may be supported catalysts using a conductive carrier such as a carbon material or may be non-supported catalysts.

Examples of a proton-conductive material forming the electrolyte membrane 17 are fluorine-based resins such as a perfluorosulfonic acid polymer having a sulfonic acid group (Nafion (product name, manufactured by Du Pont), Flemion (product name, manufactured by Asahi Glass Co., Ltd.), and the like), organic materials such as hydrocarbon-based resin having a sulfonic acid group, and inorganic materials such as tungstic acid and phosphotungstic acid. However, the proton-conductive electrolyte membrane 17 is not limited to any of these.

The anode gas diffusion layer 12 stacked on the anode catalyst layer 11 not only serves to uniformly supply the fuel to the anode catalyst layer 11 but also serves as a current collector of the anode catalyst layer 11. The cathode gas diffusion layer 15 stacked on the cathode catalyst layer 14 not only serves to uniformly supply an oxidant to the cathode catalyst layer 14 but also serves as a current collector of the cathode catalyst layer 14. The anode gas diffusion layer 12 and the cathode gas diffusion layer 15 are each made of a porous carbonaceous material such as carbon paper, carbon cloth, or carbon silk, a porous substance or mesh made of a metal material such as titanium, a titanium alloy, stainless steel, or gold, or the like.

The anode conductive layer 18 stacked on a surface of the anode gas diffusion layer 12 and the cathode conductive layer 19 stacked on a surface of the cathode gas diffusion layer 15 are each made of, for example, a porous layer (for example, mesh or the like) or a foil made of a metal material such as gold or nickel, a complex material in which a conductive metal material such as stainless steel (SUS) is coated with a highly conductive metal such as gold, or the like. Among these, the anode conductive layer 18 and the cathode conductive layer 19 are each preferably made of a thin film having a plurality openings formed in correspondence to the fuel cell unit 10, and through the openings, the fuel from the openings 31 of the fuel distribution layer 30 provided to face the fuel cell unit 10 is led to the fuel cell unit 10. Incidentally, the anode conductive layer 18 and the cathode conductive layer 19 are structured so as to prevent the leakage of the fuel and the oxidant from peripheral edges thereof. Further, between the electrolyte membrane 17 and the anode conductive layer 18 and between the electrolyte membrane 17 and the cathode conductive layer 19, O-rings 20 made of rubber are interposed respectively, and the O-rings 20 prevent the fuel leakage and the oxidant leakage from the fuel cell unit 10. Here, the fuel cell 1 including the anode conductive layer 18 and the cathode conductive layer 19 is shown, but without the anode conductive layer 18 and the cathode conductive layer 19 being provided, the anode gas diffusion layer 12 and the cathode gas diffusion layer 15 may function not only as the diffusion layers as described above but also as the conductive layers.

The moisture retention layer 50 is impregnated with part of water generated in the cathode catalyst layer 14 to prevent the transpiration of the water and promote the uniform diffusion of air to the cathode catalyst layer 14. The moisture retention layer 50 is formed by a flat plate made of a polyethylene porous film, for instance.

The surface cover 60 adjusts an intake amount of air, and for the adjustment, the number, the size, or the like of the air inlet ports 61 are changed. The surface cover 60 is preferably made of a stainless steel alloy such as SUS304 or SUS306L or made of metal such as titanium or a titanium alloy, for instance.

Further, as shown in FIG. 2, on a surface of the surface cover 60, the plural channel support members 70 for supporting the heating part 44a of the channel 44 are fixed at positions where they do not close the air inlet ports 61. The channel support members 70 have a function of supporting the heating part 44a of the channel 44 and also have a function of transferring heat from the surface cover 60 to the channel 44. Therefore, a contact area between the channel support members 70 and the surface cover 60 is preferably wide, and the channel support members 70 are preferably attached to the surface cover 60 by soldering, welding, or the like, for instance. Through holes inside the channel support members 70 have cross-sectional shapes corresponding to the shape of the channel 44 so that the channel 44 can be inserted therethrough, and the channel support members 70 are each made of a cylindrical metal member covering the periphery of the channel 44. Further, an inside diameter and so on of the through holes of the channel support members 70 are set so that inner peripheries of the channel support members 70 come into close contact with an outer surface of the channel 44 when the channel 44 is inserted to the channel support members 70. Further, between the channel 44 and the channel support members 70, a heat conductive grease (commonly called thermal grease), a heat conductive adhesive, or the like may be interposed, thereby improving heat conduction between the channel 44 and the channel support members 70.

In the example shown here, the shape of each of the channel support members 70 is a cylindrical shape but is not limited to this. For example, the channel support members 70 each may be made of a metal member having a U-shaped inner cross section so as to allow the channel 44 to fit therein, for example. Further, the U-shaped grooves are formed so that inner wall surfaces of the channel support members 70 come into close contact with the outer surface of the channel 44 when the channel 44 is fit therein.

The fuel supply mechanism 40 mainly includes the fuel storage part 41, a fuel supply part main body 42, and the channel 44.

The liquid fuel F appropriate for the fuel cell unit 10 is stored in the fuel storage part 41. The fuel storage part 41 is made of a material that is not melted or deteriorated by the liquid fuel F. Concrete examples used as the material forming the fuel storage part 41 are polyethylene (PE), polypropylene (PP), polyetheretherketone (PEEK; trademark of Victrex), and the like. Incidentally, a fuel supply port, not shown, for supplying the liquid fuel F is provided in the fuel storage part 41.

Examples of the liquid fuel F include methanol fuels such as methanol aqueous solutions with various concentrations and pure methanol. The liquid fuel F is not limited to the methanol fuel. The liquid fuel F may be, for example, an ethanol fuel such as an ethanol aqueous solution or pure ethanol, a propanol fuel such as a propanol aqueous solution or pure propanol, a glycol fuel such as a glycol aqueous solution or pure glycol, or other liquid fuels of dimethyl ether or formic acid. In any case, a liquid fuel according to the fuel cell unit 10 is stored in the fuel storage part 41.

The fuel supply part main body 42 includes the fuel supply part 43 formed by a concave portion for flatly dispersing the liquid fuel F in order to uniformly supply the supplied liquid fuel F to the fuel distribution layer 30. The fuel supply part 43 is connected to the fuel storage part 41 via the channel 44 for the liquid fuel F made of a pipe or the like.

Further, as shown in FIG. 1 and FIG. 2, part of the channel 44 is fixed by the channel support members 70 provided on the surface of the surface cover 60, in a spiral layout from a center toward an outer side (edge portion) of the surface cover 60. The channel 44 is disposed in the spiral layout so as not to close the air inlet ports 61 of the surface cover 60. Further, the channel 44 is disposed with its channel intersection portions being deformed so that one channel crosses over the other channel, for instance. In the channel 44, the portion disposed on the surface of the surface cover 60 and fixed by the channel support members 70 function as the heating part. Heat generated in the cathode (air electrode) 16 is transferred to the heating part 44a via the channel support members 70 from the surface cover 60 to heat the liquid fuel F flowing in the heating part 44a. On the other hand, as a result of heating the liquid fuel F, the cathode (air electrode) side is cooled. That is, the heating part 44a of the channel 44 has a function as a heat exchanger. The liquid fuel F is heated to a temperature in a temperature range not causing its vaporization in the heating part 44a. The fuel thus heated and supplied to the fuel supply part 43 has a higher temperature than when it is stored in the fuel storage part 41 and is liable to vaporize. Therefore, an amount of the fuel supplied to the fuel cell unit 10 via the fuel distribution layer 30 increases.

Here, the reason why the heating part 44a of the channel 44 is fixed in the spiral layout from the center toward the outer side of the surface cover 60 is that the temperature of the center portion of the surface cover 60 is the highest in the fuel cell 1. That is, the reason is that, due to a large difference between the temperature in the center portion of the surface cover 60 and the temperature of the liquid fuel F, a large quantity of the heat is exchanged. On the other hand, in the edge portion, a quantity of the heat exchanged is small due to a small difference between the temperature of the surface cover 60 and the temperature of the liquid fuel F. This makes it possible to lower the temperature in the center portion and reduce the temperature difference between the center portion and the edge portion, thereby unifying the surface temperature of the surface cover 60.

It should be noted that the above-described layout structure of the heating part 44a is on the premise that the temperature of the center portion is the highest in the surface cover 60, and in a case of a fuel cell in which the temperature of another portion is the highest in the surface cover 60, it is preferable that the heating part 44a of the channel 44 is fixed in a spiral layout from the highest-temperature portion toward a lowest-temperature portion. Further, the layout structure of the heating part 44a of the channel 44 is not limited to the structure in which it is fixed in the spiral layout from the center toward the outer side of the surface cover, but it is only necessary that the heating part 44a is laid out from the center toward the outer side of the surface cover 60, that is, from the highest-temperature portion toward the lowest-temperature portion. Examples of this structure include the structure in which the heating part 44a is fixed in a radial layout from the center toward the outer side of the surface cover 60 in two directions or more, and the like. Incidentally, without the channel support members 70 being provided, the heating part 44a of the channel 44 may be fixed directly to the surface of the surface cover 60.

Further, the channel 44 is preferably made of a substance that is not melted or deteriorated by the liquid fuel F and has high heat conductivity. Concrete materials forming the channel 44 are metals such as stainless steel, copper, and aluminum, ceramics such as alumina ceramics, clayware, and glass, resins such as polyethylene, polypropylene, polystyrene, polyethylene telephthalate, nylon, polyetheretherketone (PEEK), polytetrafluoroethylene (PTFE), tetrafluoroethylene perfluoroalkyl vinyl ether copolymer (PFA), polyvinyl chloride, polyimide, and silicone resin, rubber such as ethylene propylene rubber (EPDM) and fluorine rubber, and so on. Further, heat conductive resin in which powder of carbon, metal, or the like is mixed in any of these resins may be used.

Here, in order for the channel 44 to have high heat conductivity and have high strength even with a small thickness, the channel 44 is preferably made of metal. In particular, the use of copper (heat conductivity at 20° C. is 370 W/(mK)) or aluminum (heat conductivity at 20° C. is 204 W/(mK)) is preferable since they have high heat conductivity. However, when the channel 44 is made of a metal material, there is a possibility that oxygen, organic acid such as formic acid, and the like dissolved in small amount in the liquid fuel F oxidize or corrode the channel 44. To prevent the oxidation and the corrosion, the use of a metal material such as stainless steel (heat conductivity at 20° C. is 15 W/(mK)) not easily corroded is preferable. Further, it is preferable that an inner wall surface of the channel 44 in contact with the liquid fuel F is metal-plated or is coated with resin or rubber, or is coated with a coating material insoluble in the liquid fuel F. As resin or rubber for coating, the aforesaid material forming the channel 44 is preferably used. When resin or rubber is used as the coating material, it is preferable to form a coating film as thin as possible at the time of the coating since these materials are lower in heat conductivity than metal.

In order to prevent the oxidation and the corrosion by the liquid fuel F in the channel 44, the channel 44 is preferably made of resin or rubber. However, resin and rubber are lower in heat conductivity than metal or the like (normally 0.1 to 0.5 W/(mK))) as described above, and therefore, when the channel 44 is made of resin or rubber, the thickness thereof is preferably as small as possible. Here, in order to prevent strength deterioration caused by the reduction in thickness of the channel 44 and in order to improve heat conductivity between the channel 44 and the surface cover 60, the surface of the channel 44 may be partly or entirely covered by a material such as metal. In this case, in order to improve heat conductivity between the channel 44 and the metal material, a heat conductive grease (commonly called thermal grease), a heat conductive adhesive, or the like may be interposed between the channel 44 and the metal material covering the surface of the channel 44.

The example is shown where in the above-described fuel cell 1, the heating part 44a of the channel 44 is fixed in the spiral layout from the center toward the outer side of the surface cover 60, but it should be noted that the structure is not limited to this.

For example, in view of preventing the local formation of a high-temperature portion in the surface of the fuel cell 1 and cooling the cathode (air electrode) side, the heating part 44a of the channel 44 may be fixed in a circumferential layout along an edge portion of the surface cover 60 as shown in FIG. 3. Further, when the temperature of the liquid fuel F supplied to the fuel supply part 43 becomes excessively high, a heat exchanger functioning as a heat release mechanism radiating the heat of the liquid fuel F flowing in the channel to an outside air may be provided on a portion, of the channel 44, between the heating part 44a of the channel 44 and the fuel supply part 43. The structure of the heat exchanger is the same as the structure of a heat exchanger described next with reference to FIG. 4.

Further, as shown in FIG. 4, on a downstream side of the heating part 44a of the channel 44, the channel 44 may branch off into two channels so that the channel is switchable therebetween by a channel switching valve 45, and in a channel 44b on one side, a heat exchanger 46 functioning as a heat release mechanism radiating the heat of the liquid fuel F flowing in the channel to the outside air may be provided. A channel 44c on the other side is formed by the same channel as the channel 44 shown in FIG. 1. This heat exchanger 46 includes a plurality of plate-shaped fins on a periphery of a side surface of the channel 44b as shown in FIG. 4, for instance. One end of each of the plate-shaped fins is fixed to the periphery of the side surface of the channel 44b by welding or the like, for instance. It should be noted that the structure of the heat exchanger 46 is not limited to this structure, but may be any structure capable of promoting heat exchange with the outside air by increasing a surface area.

For example, when the fuel in an amount larger than an amount capable of reacting in the anode catalyst layer 11 is supplied to the anode catalyst layer 11, the fuel not having reacted permeates through the electrolyte membrane 17 to reach the cathode catalyst layer 14, and the fuel sometimes reacts with air in the cathode catalyst layer 14. In such a case, the temperature of the liquid fuel F supplied to the fuel supply part 43 sometimes becomes too high, but the channel switching valve 45 switches the channel of the liquid fuel F from the channel 44c for regular flow of the liquid fuel F to the channel 44b including the heat exchanger 46, so that the heat that the liquid fuel F absorbs in the heating part 44a of the channel 44 can be partly radiated to the surrounding atmosphere or the like. This can prevent the liquid fuel F having the excessively high temperature from being supplied to the fuel supply part 43. Another possible structure may be that a temperature detecting device such as, for example, a thermocouple measuring the temperature of the liquid fuel F flowing in the channel 44 is provided between the heating part 44a of the channel 44 and the channel switching valve 45 and a controller (not shown) controls the channel switching valve 45 based on the detected temperature.

Another possible structure may be, as shown in FIG. 5, that a through hole 80 having a hole diameter large enough to allow the channel 44 to be inserted therethrough is provided at the center of the fuel cell 1, that is, the through hole 80 communicating with the centers of the fuel supply part main body 42, the fuel distribution layer 30, the anode conductive layer 18, the fuel cell unit 10, the cathode conductive layer 19, the moisture retention layer 50, and the surface cover 60 and having a hole diameter large enough to allow the channel 44 to be inserted therethrough is formed, and the channel 44 is inserted to the through hole 80 to be drawn out toward the surface cover 60 side. Here, the hole diameter of the through hole 80 is set substantially equal to an outside diameter of the channel 44 or slightly larger than the outside diameter of the channel 44. Since O-rings 20 are inserted to portions, of the through hole 80, facing the anode (fuel electrode) 13 and the cathode (air electrode) 16, these portions of the through hole 80 are formed to have a slightly larger hole diameter than the hole diameter of the other portion. Here, on the through hole side, between the electrolyte membrane 17 and the anode conductive layer 18 and between the electrolyte membrane 17 and the cathode conductive layer 19, the O-rings 20 made of rubber are interposed respectively to prevent the fuel leakage and the oxidant leakage. Further, a sealant 81 made of, for example, ethylene propylene rubber (EPDM) seals a gap between the fuel supply part main body 42 and the channel 44 to prevent the fuel from flowing out of the fuel supply part 43. In the channel 44 drawn out toward the surface cover 60 side via the through hole 80, the heating part 44a of the channel 44 is fixed to the surface of the surface cover 60 in the same layout structure as the above-described layout structure.

The liquid fuel F stored in the fuel storage part 41 can be sent to the fuel supply part 43 via the channel 44 by being dropped with the use of gravity. Further, by filling a porous body in the channel 44, the liquid fuel F stored in the fuel storage part 41 may be sent to the fuel supply part 43 by capillary action. Further, as shown in FIG. 6, by providing a pump 85 in part of the channel 44, the liquid fuel F stored in the fuel storage part 41 may be forcibly sent to the fuel supply part 43.

The pump 85 functions as a supply pump simply sending the liquid fuel F from the fuel storage part 41 to the fuel supply part 43 and does not have a function as a circulation pump circulating an excessive amount of the liquid fuel F supplied to the fuel cell unit 10. Not circulating the fuel, the fuel cell 1 including the pump 85 has a different structure from the structure of a conventional active type and also has a different structure from the structure of a pure passive type such as a conventional internal vaporization type, and corresponds to what is called a semi-passive type. The kind of the pump 85 functioning as a fuel supplier is not limited to a specific one, but a rotary vane pump, an electroosmotic flow pump, a diaphragm pump, a squeeze pump, or the like is preferably used in view of that each of them is capable of sending a small amount of the liquid fuel F with good controllability and can be reduced in size and weight. The rotary vane pump rotates a vane by a motor for fuel sending. The electroosmotic flow pump uses a sintered porous body such as silica causing an electroosmotic phenomenon. The diaphragm pump sends liquid by driving a diaphragm by an electromagnet or piezoelectric ceramics. The squeeze pump squeezes and sends the fuel by pressing part of a fuel channel having flexibility. Among them, the electroosmotic flow pump or the diaphragm pump having the piezoelectric ceramics is preferably used in view of the strength of driving power and the like. When the pump 85 is provided as described above, the pump 85 is electrically connected to a controller (not shown) and the controller controls a supply amount of the liquid fuel F supplied to the fuel supply part 43.

The fuel distribution layer 30 is made of, for example, a flat plate in which a plurality of openings 31 are formed and is sandwiched between the anode gas diffusion layer 12 and the fuel supply part 43. The fuel distribution layer 30 is made of a material not allowing the permeation of a vaporized component of the liquid fuel F or the liquid fuel F, and concretely, is made of, for example, polyethylene telephthalate (PET) resin, polyethylene naphthalate (PEN) resin, polyimide-based resin, or the like. Alternatively, the fuel distribution layer 30 may be made of a gas-liquid separation film separating the vaporized component of the liquid fuel F and the liquid fuel F and allowing the permeation of the vaporized component to the fuel cell unit 10 side. As the gas-liquid separation film, used is, for example, silicone rubber, a low-density polyethylene (LDPE) thin film, a polyvinyl chloride (PVC) thin film, a polyethylene telephthalate (PET) thin film, a fluororesin (for example, polytetrafluoroethylene (PTFE), a tetrafluoroethylene perfluoroalkyl vinyl ether copolymer (PFA) or the like) micro-porous film, or the like.

Next, the operation in the above-described fuel cell 1 will be described.

The liquid fuel F led out from the fuel storage part 41 toward the fuel supply part 43 via the channel 44 passes through the heating part 44a of the channel 44 to be heated by the heat generated in the cathode (air electrode) 16. Then, the heated liquid fuel F is supplied to the fuel supply part 43, and the liquid fuel F as it is or the liquid fuel F mixed with a vaporized fuel generated by the vaporization of the liquid fuel F is supplied to the anode gas diffusion layer 12 of the fuel cell unit 10 via the fuel distribution layer 30 and the anode conductive layer 18. The fuel supplied to the anode gas diffusion layer 12 diffuses in the anode gas diffusion layer 12 to be supplied to the anode catalyst layer 11. When a methanol fuel is used as the liquid fuel, an internal reforming reaction of methanol expressed by the following expression (1) occurs in the anode catalyst layer 11.

CH₃OH+H₂O→CO₂+6H⁺+6e⁺ expression (1)

When pure methanol is used as the methanol fuel, methanol is reformed by the internal reforming reaction of the above expression (1) with water generated in the cathode catalyst layer 14 or water in the electrolyte membrane 17, or is reformed by another reaction mechanism not requiring water.

Electrons (e⁻) generated in this reaction are led to the outside via the current collector, and after working as what is called electricity to operate a portable electronic device or the like, the electrons (e⁻) are led to the cathode (air electrode) 16. Further, protons (H⁺) generated in the internal reforming reaction of the expression (1) are led to the cathode (air electrode) 16 via the electrolyte membrane 17. Air is supplied as the oxidant to the cathode (air electrode) 16. In the cathode catalyst layer 14, the electrons (e⁻) and the protons (H⁺) having reached the cathode (air electrode) 16 make a reaction expressed by the following expression (2) with oxygen in the air, and the power generation reaction is accompanied by the generation of water.

( 3/2)O₂+6e⁻+6H⁺→3H₂O expression (2)

The above-described internal reforming reaction smoothly takes place and high and stable output can be obtained in the fuel cell 1.

According to the fuel cell 1 of the first embodiment according to the present invention described above, the heating part 44a of the channel 44 is fixed in the layout from the center portion toward the outer side of the surface of the surface cover 60, and by transferring a large quantity of heat to the liquid fuel F at the center portion of the surface cover 60 where the temperature becomes highest, it is possible to lower the temperature of the center portion of the surface cover 60, reduce a temperature difference between the center portion and the edge portion, and equalize the surface temperature of the surface cover 60. This can improve safety when the fuel cell 1 is used. Further, an effect of cooling the cathode (air electrode) side is also obtained.

Further, the fuel heated in the heating part 44a of the channel 44 and supplied to the fuel supply part 43 has a higher temperature than when it is stored in the fuel storage part 41 and is liable to vaporize, which makes it possible to increase an amount of the fuel supplied to the fuel cell unit 10 via the fuel distribution layer 30. Consequently, it is possible to increase the output as the whole fuel cell if an amount of the fuel supplied to the fuel cell unit 10 is in a proper range.

### Second Embodiment

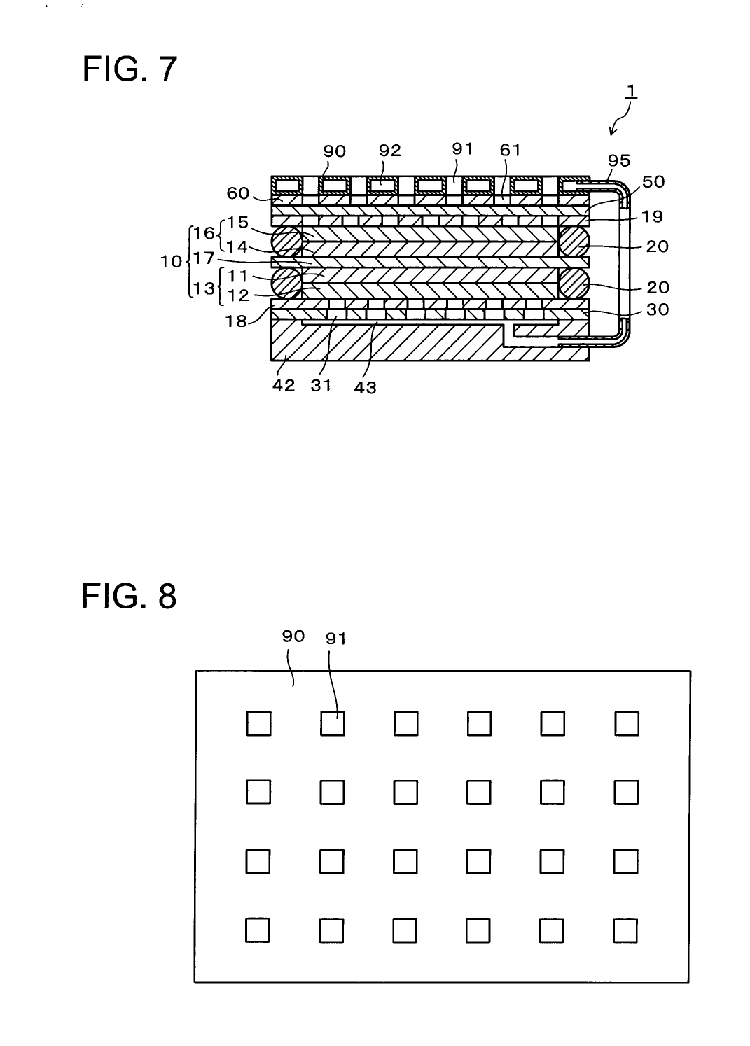

FIG. 7 is a cross-sectional view showing the structure of a fuel cell 1 of a second embodiment according to the present invention. FIG. 8 is a plane view showing the structure when the fuel cell 1 in FIG. 7 is seen from above the fuel cell 1. The same components as those of the fuel cell 1 of the first embodiment will be denoted by the same reference numerals and symbols and redundant description thereof will be simplified.

As shown in FIG. 7, the fuel cell 1 includes: a fuel cell unit 10 constituting an electromotive part; an anode conductive layer 18 and a cathode conductive layer 19 provided on an anode (fuel electrode) side and a cathode (air electrode) side of the fuel cell unit 10 respectively; a fuel distribution layer 30 disposed to face the anode conductive layer 18 and having a plurality of openings 31; a fuel supply part 43 disposed opposite the fuel cell unit 10 across the fuel distribution layer 30 to supply a liquid fuel F to the fuel distribution layer 30; a moisture retention layer 50 stacked on the cathode conductive layer 19; a surface cover 60 stacked on the moisture retention layer 50 and having a plurality of air inlet ports 61; a fuel storage part 90 provided on the surface cover 60; and a channel 95 via which the fuel storage part 90 and the fuel supply part 43 communicate with each other.

As shown in FIG. 7, the fuel storage part 90 is a casing having openings 91 provided in correspondence to the air inlet ports 61 of the surface cover 60, and hollow portions 92 therein communicate with one another except the openings 91. For the purpose of efficient conduction of heat from the surface cover 60 to the fuel storage part 90, the fuel storage part 90 is preferably fixed to a surface of the surface cover 60 by, for example, soldering, welding, an adhesive, or the like according to materials forming the surface cover 60 and the fuel storage part 90. Further, the channel 95 is provided between the fuel storage part 90 and the fuel supply part 43 to lead the liquid fuel F stored in the fuel storage part 90 to the fuel supply part 43. A fuel supply port, not shown, for supplying the liquid fuel F is provided in the fuel storage part 90.

The material forming the fuel storage part 90 is preferably a substance not easily melted or deteriorated by the liquid fuel F and having high heat conductivity. Concrete examples used as the material forming the fuel storage part 41 are metals such as stainless steel, copper, and aluminum, materials in which inner surfaces of these metals are plated with gold or the like, materials coated with resin, rubber, or a coating material, ceramics such as alumina ceramics, clayware, or glass, and so on.

The channel 95 is made of a material not melted or deteriorated by the liquid fuel F. Concrete examples used as the material forming the channel 95 are metals such as stainless steel, copper, and aluminum, materials in which inner surfaces of these metals are plated with gold or the like, materials coated with resin, rubber, a coating material, or the like, resins such as polyethylene (PE), polypropylene (PP), polystyrene (PS), polyethylene telephthalate (PET), nylon, polyetheretherketone (PEEK), polytetrafluoroethylene (PTFE), tetrafluoroethylene perfluoroalkyl vinyl ether copolymer (PFA), polyvinyl chloride (PVC), polyimide (PI), and silicone, rubber such as ethylene propylene rubber (EPDM) and fluorine rubber, and so on.

Here, the liquid fuel F stored in the fuel storage part 90 is heated by heat generated in the cathode (air electrode) 16 and transferred from the surface cover 60. The liquid fuel F heated in the fuel storage part 90 is led out toward the fuel supply part 43 via the channel 95. The operation thereafter in the fuel cell 1 is the same as the operation in the fuel cell 1 of the first embodiment described above. The liquid fuel F is heated in the fuel storage part 90 to a temperature in a temperature range not causing its vaporization. The fuel thus heated and supplied to the fuel supply part 43 is liable to vaporize, and therefore, an amount of the fuel supplied to the fuel cell unit 1 via the fuel distribution layer 30 increases.

The liquid fuel F stored in the fuel storage part 90 can be sent to the liquid supply part 43 via the channel 95 by being dropped with the use of gravity. Alternatively, by filling a porous body in the channel 95, the liquid fuel F stored in the fuel storage part 90 may be sent to the fuel supply part 43 by capillary action. Further, as in the fuel cell 1 shown in FIG. 6, by providing a pump in part of the channel 95, the liquid fuel F stored in the fuel storage part 90 may be forcibly sent to the fuel supply part 43.

According to the fuel cell 1 of the second embodiment according to the present invention described above, since the fuel storage part 90 is provided on the surface of the surface cover 60, the liquid fuel F in the fuel storage part 90 is heated and is led into the fuel storage part 43 in the state of being liable to vaporize, which makes it possible to increase an amount of the fuel supplied to the fuel cell unit 10 via the fuel distribution layer 30. If an amount of the fuel supplied to the fuel cell unit 10 is in a proper range, it is possible to increase the output as the whole fuel cell.

Further, since the heat is received from the surface cover 60, it is possible to lower the temperature of a high-temperature portion of the surface cover 60 and reduce a temperature difference between a center portion and an edge portion of the surface cover 60, thereby equalizing a surface temperature of the surface cover 60. This can improve safety when the fuel cell 1 is used. Further, an effect of cooling the cathode (air electrode) side is also obtained.

Next, it will be described based on examples 1, 2 and a comparative example 1 that the fuel cell according to the present invention has an excellent output characteristic.

### Example 1

A fuel cell used in the example 1 will be described with reference to FIG. 6 since it includes the same structure as that of the fuel cell 1 shown in FIG. 6.

First, a method of fabricating a fuel cell unit 10 will be described.

A perfluorocarbon sulfonic acid solution as proton conductive resin, and water and methoxypropanol as dispersion mediums were added to carbon black carrying anode catalyst particles (Pt:Ru=1:1), and the carbon black carrying the anode catalyst particles were dispersed, whereby paste was prepared. The obtained paste was applied on porous carbon paper (40 mm×30 mm rectangle) being an anode gas diffusion layer 12, whereby an anode catalyst layer 11 with a 100 μm thickness was obtained.

A perfluorocarbon sulfonic acid solution as proton conductive resin, and water and methoxypropanol as dispersion mediums were added to carbon black carrying cathode catalyst particles (Pt), and the carbon black carrying the cathode catalyst particles were dispersed, whereby paste was prepared. The obtained paste was applied on porous carbon paper being a cathode gas diffusion layer 15, whereby a cathode catalyst layer 14 with a 100 μm thickness was obtained. Incidentally, the anode gas diffusion layer 12 and the cathode gas diffusion layer 15 have the same shape and size, and the anode catalyst layer 11 and the cathode catalyst layer 14 applied on these gas diffusion layers also have the same shape and size.

Between the anode catalyst layer 11 and the cathode catalyst layer 14 fabricated in the above-described manner, a perfluorocarbon sulfonic acid film (product name: nafion film manufactured by Du Pont) with a 30 μm thickness and with a 10 to 20 wt % water content was disposed as an electrolyte membrane 17, and hot pressing was performed while the anode catalyst layer 11 and the cathode catalyst layer 14 are positioned so as to face each other, whereby a fuel cell unit 10 was obtained.

Subsequently, the fuel cell unit 10 is sandwiched by metal foils having a plurality of openings, whereby an anode conductive layer 18 and a cathode conductive layer 19 were formed. Between the electrolyte membrane 17 and the anode conductive layer 18 and between the electrolyte membrane 17 and the cathode conductive layer 19, O-rings 20 made of rubber are interposed respectively for sealing.

Further, as a moisture retention layer 50, used was a polyethylene porous film with a 500 μm thickness, 2 sec./100 cm³ air permeability (according to a measuring method defined in JIS P-8117), and 4000 g/(m²·24 h) water vapor permeability (according to a measuring method defined in JIS L-1099 A-1).

As a surface cover 60, a stainless steel plate (SUS304) having air inlet ports 61 (2.5 mm×2.5 mm rectangle, the number of openings 48) for air intake and having a 1 mm thickness was disposed on the moisture retention layer 50. On a surface of the surface cover 60, SUS thin pipes with a 3 mm inside diameter serving as channel support members 70 are welded so as to correspond to the layout pattern of a channel 44.

As the channel 44, a PFA cylindrical pipe with a 1 mm inside diameter and a 3 mm outside diameter was used. A heating part 44a of the channel 44 was inserted through the SUS thin pipes welded on the surface of the surface cover 60 and was fixed in a spiral layout from a center toward an outer side of the surface cover 60.

Further, a squeeze pump was used as a pump 85, and a liquid fuel F stored in a fuel storage part 41 was sent to a fuel supply part 43 by a pressure caused by squeezing part of the channel 44 in a predetermined direction. Here, a control circuit controlling the number of rotation of the squeeze pump according to a current flowing through the fuel cell 1 was structured, and the control circuit performs a control operation so that the fuel in an amount 1.4 times a fuel supply amount necessary for causing an electrochemical reaction in the fuel cell 1 (a 3.3 mg methanol supply amount per minute for 1 A current) was constantly supplied.

Then, under the environment of a 25° C. temperature and a 50% relative humidity, pure methanol with a 99.9 wt. % purity and in the above supply amount was supplied to the aforesaid fuel cell 1. A constant voltage power source as an external load was connected, and a current flowing in the fuel cell 1 was controlled so that an output voltage of the fuel cell 1 became constantly 0.3 V. A product of the current (A) flowing in the fuel cell 1 at this time and the output voltage (V) of the fuel cell 1 is an output (W) of the fuel cell.

Under the aforesaid condition, 100-hour power generation was performed and the output of the fuel cell 1 during this 100-hour period was measured. Then, an average value of the output of the fuel cell 1 during the 100-hour period was calculated. Here, the average value of the output was calculated in a manner that the current flowing in the fuel cell 1 and the output voltage were recorded in a digital recorder, a cumulative power (unit Wh) was calculated from the recorded values, and the cumulative power was divided by the power generation time (100 hours). Further, surface temperatures of a center portion and an edge portion of the surface cover 60 during the 100-hour period were measured by using a thermocouple, and the results were recorded in the digital recorder. From the recorded data, the maximum values of the surface temperatures of the center portion and the edge portion of the surface cover 60 were obtained.

As a result of the measurement, the average value of the output was 1 W. Further, the maximum value of the surface temperature of the center portion of the surface cover 60 was 45° C. and the maximum value of the surface temperature of the edge portion was 41° C.

### Example 2

The structure of a fuel cell 1 used in the example 2 was the same as the structure of the fuel cell 1 used in the example 1 except in that a through hole through which a channel 44 is inserted was provided in the center of the fuel cell 1 used in the example 1. Further, the structure of the fuel cell 1 used in the example 2 was the same as the structure of the fuel cell 1 shown in FIG. 5 except in that a pump was provided, and therefore, a description will be given with reference to FIG. 5.

As shown in FIG. 5, the through hole 80 having a hole diameter slightly larger than 3 mm to allow the channel 44 (a PFA cylindrical pipe with a 1 mm inside diameter and a 3 mm outside diameter) to be inserted therethrough was formed so as to pass through the center of the fuel cell 1, that is, the centers of a fuel supply part main body 42, a fuel distribution layer 30, an anode conductive layer 18, a fuel cell unit 10, a cathode conductive layer 19, a moisture retention layer 50, and a surface cover 60. Then, the channel 44 was inserted through the through hole 80 to be drawn out toward the surface cover 60 side. Further, a hole diameter of portions, of the through hole 80, corresponding to an anode (fuel electrode) 13 and a cathode (air electrode) 16 was set to 5 mm so as to allow O-rings 20 to be inserted therein. Further, on the through hole side, between an electrolyte membrane 17 and the anode conductive layer 18 and between the electrolyte membrane 17 and the cathode conductive layer 19, rubber O-rings 20 (a 3 mm inside diameter and a 5 mm outside diameter) were interposed respectively to prevent fuel leakage and oxidant leakage. Further, a sealant 81 made of EPDM sealed a gap between a fuel supply part main body 42 and the channel 44 to prevent a fuel from flowing out of a fuel supply part 43. In the channel 44 drawn out toward the surface cover 60 side via the through hole 80, the layout structure of a heating part 44a of the channel 44 was the same as the layout structure of the heating part 44a of the channel 44 in the example 1.

As the pump, the same squeeze pump as the pump used in the example 1 was used, and part of the channel 44 was squeezed in a predetermined direction to generate a pressure, thereby sending the liquid fuel F stored in a fuel storage part 41 to the fuel supply part 43. Here, a control circuit controlling the number of rotation of the squeeze pump according to a current flowing in the fuel cell 1 was structured, and the number of rotation of the squeeze pump was controlled so that the fuel in an amount 1.4 times a fuel supply amount necessary for causing an electrochemical reaction in the fuel cell 1 (a 3.3 mg methanol supply amount per minute for a 1 A current) was constantly supplied.

The structure and set values other than those described above were the same as those of the fuel cell 1 used in the example 1. Further, measuring methods, measuring conditions, calculation methods, and so on of an average value of an output of the fuel cell 1 and the maximum values of surface temperatures of a center portion and an edge portion of the surface cover 60 during a 100-hour period were the same as those in the example 1.

As a result of the measurement, the average value of the output was 0.99 W. Further, the maximum value of the surface temperature of the center portion of the surface cover 60 was 44° C. and the maximum value of the surface temperature of its edge portion was 41° C.

### Comparative Example 1

A fuel cell used in the comparative example 1 was structured such that in the fuel cell 1 used in the example 1, the heating part 44a of the channel 44 was not provided and the channel 44 was disposed so that the liquid fuel F led out from the fuel storage part 41 was directly supplied to the fuel supply part 43. The other structure was the same as the structure of the fuel cell 1 used in the example 1. That is, the fuel cell used in the comparative example 1 does not have the structure for heating the liquid fuel F before it is supplied to the fuel storage part 41, nor does it have the structure for lowering the temperature of the surface cover 60.

The structure and set values other than those described above are the same as those of the fuel cell 1 used in the example 1. Further, measuring methods, measuring conditions, calculation methods, and so on of an average value of an output of the fuel cell 1 and the maximum values of surface temperatures of a center portion and an edge portion of a surface cover 60 during a 100-hour period were the same as those in the example 1.

As a result of the measurement, the average value of the output was 0.93 W. Further, the maximum value of the surface temperature of the center portion of the surface cover 60 was 48° C. and the maximum value of the surface temperature of its edge portion was 38° C.

(Summary of the example 1, the example 2, and the comparative example 1)

Table 1 shows the average value of the output and the maximum values of the surface temperatures of the center portion and the edge portion of the surface cover 60 in the example 1, the example 2, and the comparative example 1.

TABLE 1

| | | maximum value | maximum value |
|---|---|---|---|
| | average value | of temperature | of temperature |
| | of output | of center portion | of edge portion |
| | of fuel cell W | ° C. | ° C. |
| example 1 | 1 | 45 | 41 |
| example 2 | 0.99 | 44 | 41 |
| comparative | 0.93 | 48 | 38 |
| example 1 | | | |

As shown in Table 1, it has been found out that in the fuel cells of the example 1 and the example 2, the maximum value of the temperature in the center portion of the surface cover 60 is low and a difference between the maximum values of the temperatures in the center portion and the edge portion of the surface cover 60 is small, compared with those of the fuel cell in the comparative example 1. Further, it has been found out that in the fuel cells in the example 1 and the example 2, the average values of the outputs in the fuel cells are high compared with that of the fuel cell in the comparative example 1. It is thought that the reason why the average value of the output in the example 2 is slightly lower than that in the example 1 is that a power generation area was reduced by an amount of an area of the through hole formed in the fuel cell unit 10.

The present invention is applicable to various kinds of fuel cells using a liquid fuel. Further, the concrete structure of the fuel cell, the supply state of the fuel, and so on are not limited to specific ones. For example, the present invention is applicable to various types such as a type in which a liquid fuel is directly distributed under an anode conductive layer, an external vaporization type in which a liquid fuel is vaporized outside a fuel cell and the vaporized gaseous fuel is distributed under an anode conductive layer, and an internal vaporization type in which a liquid fuel is stored in a fuel storage part and the liquid fuel is vaporized inside the cell to be supplied to an anode catalyst layer. Further, when carried out, the present invention can be embodied with the constituent elements being modified without departing from the technical ideas of the present invention. Further, various modifications are possible such as appropriately combining the plural constituent elements shown in the above-described embodiments, deleting some constituent elements from all the constituent elements shown in the above-described embodiments. The embodiments of the present invention can be expanded or changed within a range of the technical ideas of the present invention, and the expanded and changed embodiments are also included in the technical scope of the present invention.

### INDUSTRIAL APPLICABILITY

According to the fuel cell according to the embodiments of the present invention, since the heating part of the channel of the liquid fuel is fixed so as to extend from the center portion toward the outer side of the surface of the surface cover, it is possible to transfer a large quantity of heat to the liquid fuel at the center portion of the surface cover where the temperature becomes highest. This can lower the temperature of the center portion of the surface cover and reduce a temperature difference between the center portion and the edge portion, so that a fuel cell having a uniform surface temperature in the surface cover can be realized. Further, it is possible to realize a fuel cell capable of having improved safety when in use. Further, the fuel heated in the heating part of the channel and supplied to the fuel supply part has a higher temperature than when it is stored in the fuel storage part and thus is liable to vaporize. Therefore, it is possible to realize a fuel cell in which an amount of the fuel supplied to the fuel cell unit via the fuel distribution layer can be increased. Further, the fuel cells according to the embodiments of the present invention are effectively used as fuel cells of a liquid fuel direct supply type and so on, for instance.

What is claimed is:

1. A fuel cell, comprising:
a membrane electrode assembly having a fuel electrode, an air electrode, and an electrolyte membrane sandwiched by the fuel electrode and the air electrode;
a fuel supply part disposed on the fuel electrode side of the membrane electrode assembly to supply a fuel to the fuel electrode;
a fuel storage part storing the fuel; and
a fuel channel heating and leading the fuel stored in the fuel storage part to the fuel supply part, the fuel channel heating by heat generated in the air electrode.

2. The fuel cell according to claim 1,
wherein the fuel channel has a heating part to heat the fuel by the heat generated in the air electrode, the heating part being capable of receiving the heat from a constituent member provided on the air electrode side, the heating part being laid out on a surface of the constituent member in a direction from a center portion toward an edge portion of the constituent member.

3. The fuel cell according to claim 2,
wherein the fuel channel includes a heat release mechanism between the heating part and the fuel supply part, the heat release mechanism radiating heat of the fuel flowing in the fuel channel to an outside air.

4. The fuel cell according to claim 2,
wherein on a downstream side of the heating part, the fuel channel up to the fuel supply part branches off into two fuel channels between which the channel is switchable, and between a branching portion and the fuel supply part, one of the fuel channels includes a heat release mechanism radiating heat of the fuel flowing in the one fuel channel to an outside air.

5. A fuel cell, comprising:
a membrane electrode assembly having a fuel electrode, an air electrode, and an electrolyte membrane sandwiched by the fuel electrode and the air electrode;
a fuel supply part disposed on the fuel electrode side of the membrane electrode assembly to supply a fuel to the fuel electrode;
a fuel storage part storing the fuel while heating the fuel by heat generated in the air electrode; and
a fuel channel leading the fuel stored in the fuel storage part to the fuel supply part.
